(19) United States
(12) Patent Application Publication
(10) Pub. No.: US 2006/0097852 A1
(43) Pub. Date: May 11, 2006

(54) System and method for power and data delivery on a machine

(76) Inventors: Bryan G. Lammers, Peoria Heights, IL (US); James I. Portscheller, Sparland, IL (US)

Correspondence Address: CATERPILLAR INC.;100 N.E. ADAMS STREET, PATENT DEPT., PEORIA, IL, 616296490, US

(21) Appl. No.: 11/257,571

(22) Filed: Oct. 25, 2005

Related U.S. Application Data
(60) Provisional application No. 60/626,813, filed on Nov. 10, 2004.

(51) Int. Cl. G05B 11/01

(52) U.S. Cl. 340/310.11; 340/538.11

(57) ABSTRACT

A power and data delivery system for a machine. The system includes a power and data conductor located throughout at least a portion of the machine, a plurality of processing nodes, each connected to the conductor at various locations, and a plurality of devices, each connected to a corresponding one of the plurality of processing nodes and controlled by the processing node, wherein each processing node may be connected at any location of the conductor.

This application claims the benefit of prior provisional patent application Ser. No. 60/626,813 filed Nov. 10, 2004.

### TECHNICAL FIELD

The present invention relates generally to a system and method for distributed communications on machines and more particularly to a system and method for data and power delivery over the same conductors.

### BACKGROUND

Machines are used to perform a wide variety of job functions, and may be mobile or stationary. For example, a typical machine is shown in FIG. 1 as a wheel loader, and is used for many earthworking and construction tasks. Other types of machines may include trucks, automobiles, marine craft, aircraft, dozers, graders, excavators, tractor trailers, trains, stationary electric power generators, and many others.

Typically, machines are powered, controlled and monitored using electric and electronic technology, which involves the use of electrical conductors to supply power and data to various components and locations. Traditionally, power and data are delivered on separate conductors. In machines such as this, an operator may control devices from a central location with data routed through independent data conductors dedicated to each device. Similarly, the power for any of these machines would normally originate at a power source and connect to a central location, typically a fuse block, for independent distribution on power conductors to locations throughout the machine.

In current systems, two or more conductors are required for each device. The total number of conductors required increases proportionally to the number of devices used by the machine and by the number of combinations of communications between devices, and the number is ever increasing. Future machines will require even more devices than do present machines. To minimize assembly problems on current machines, the conductors are bundled into complex and cumbersome wiring harnesses. With a larger number of conductors, the wiring harnesses become proportionally larger and proportionally harder to route around the machine. The cost and weight of the wiring harnesses also increases proportionally and the time to troubleshoot increases exponentially. For ease of assembly, harnesses typically use multiple pin connectors. Large harnesses require even larger and more expensive connectors. The addition of even one new device may require harness replacement or modification. Even when the desired conductor or connector location for service or modification is found, they may not be in a convenient location to perform the needed service or modification or to connect to new devices. Unfortunately, because of the ever-increasing percentage of machine functions being performed electronically, the problems continue to multiply.

Multiplexing has been used to try to reduce the number of individual conductors needed for electrical communication. Multiplexing is typically used to send multiple messages on a single pair of signal conductors to independent receivers of electrical data. However, present day techniques of multiplexing groups of electrical functions are only partially solving system complexity problems and are merely creating additional layers of electrical hierarchy rather than reducing complexity of the electrical systems. Although these systems and methods may be adequate for the speed and bandwidth of some of today's electrical functions, speed and capacity become a significant problem as signal activity continues to increase.

Attempts have also been made to use a data communication system where data and power are routed over the same conductors. For example, it is known in motor vehicles to arrange functional devices to communicate with each other through supply conductors connected to the battery of the vehicle by means of a carrier current technique. One such example of a data communication system employing the use of carrier currents is disclosed by U.S. Pat. No. 5,745,027, to Malville. Malville, however, does not disclose features which would enable a combination of power and data delivery throughout a machine. For example, Malville does not disclose smart connectors that connect devices to a wire bus that are configured to communicate and work with other smart connectors. Malville also does not disclose techniques in which smart connectors are readily connected to the bus at any desired location during assembly, maintenance or upgrades. Furthermore, Malville does not disclose techniques for delivering large amounts of data over a combined power and data delivery bus that accounts for and compensates for data interference in harsh environments.

In U.S. Pat. No. 5,727,025, Maryanka discloses a system that allows for voice, music, video and data to be transmitted over direct current wires. The system of Maryanka, however, does not disclose the use of smart connectors such that the interface between devices and the direct current wires has the capability to interpret commands and control devices based on decision making. Maryanka's system also does not include techniques for smart connectors being readily connected at any desired locations on the direct current lines.

### SUMMARY OF THE INVENTION

It is to be understood that both the foregoing general description and the following detailed description are exemplary and explanatory only and are not restrictive of the invention as claimed.

One aspect of the present disclosure is directed to a power and data delivery system for a machine. The system comprises a conductor located throughout at least a portion of the machine, a plurality of processing nodes, each connected to the conductor at a respective desired location, and a plurality of devices, at least one being connected to a corresponding one of the plurality of processing nodes and controlled by the processing node, wherein the desired location may be located at any point along the conductor.

Another aspect of the present invention is directed to a power and data delivery system for a machine. This aspect comprises a conductor located throughout at least a portion of the machine, a plurality of smart connectors, each smart connector connected to the conductor at any desired location, the plurality of smart connectors operable to transfer at least one of a power and data signal through the conductor, and at least one device being controllably connected to each of the plurality of smart connectors.

Another aspect of the present invention is directed to a machine having a power and data delivery system. The machine has an electrical power source, a data source, a plurality of electrically driven devices, a conductor for delivering power and data signals between the power and data sources and the plurality of devices, and a plurality of processing nodes controllably connecting the signals from the conductor to the plurality of devices, each processing node being located at any desired location on the conductor

Another aspect of the present invention is directed to a method for connecting electrical devices to at least one of a power source and a data source on a machine. The method comprises installing a conductor throughout at least a portion of the machine, connecting a processing node at any desired location along the conductor without interrupting an electrical path of the conductor, and connecting at least one electrical device to the processing node.

Another aspect of the present invention is directed to a method for controlling an electrical device on a machine. The method comprises delivering electrical power and data signals on a conductor to a processing node directly connected to any location on the conductor and delivering actuation signals from the processing node to an electrical device as a function of the electrical power and data signals.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 shows a diagrammatic illustration of a machine where one embodiment of the present disclosure may be employed;

FIG. 2 shows diagrammatically a power and data delivery system according to one embodiment of the present disclosure;

FIG. 3 is a cross section diagram of a conductor according to one embodiment of the present disclosure;

FIG. 4 is a cross section view of a smart connector plugged into the conductor according to one embodiment of the present disclosure;

FIG. 5a is a block diagram of a smart chip connected to the conductor according to one embodiment of the present disclosure;

FIG. 5b is a block diagram of two smart chips connected to the conductor according to one embodiment of the present disclosure;

FIG. 6 shows diagrammatically a power and data delivery system according to another embodiment of the present disclosure;

FIG. 7 shows diagrammatically a power and data delivery system 40 according to another embodiment of the present disclosure

FIG. 8 shows diagrammatically a power and data delivery system according to another embodiment of the present disclosure; and

FIG. 9 is a flow diagram depicting steps of operation of a power and data delivery system according to one embodiment of the present disclosure.

### DETAILED DESCRIPTION

Reference will now be made in detail to embodiments of the invention, examples of which are illustrated in the accompanying drawings. Whenever possible, the same reference numbers will be used throughout the drawings to refer to the same or like parts.

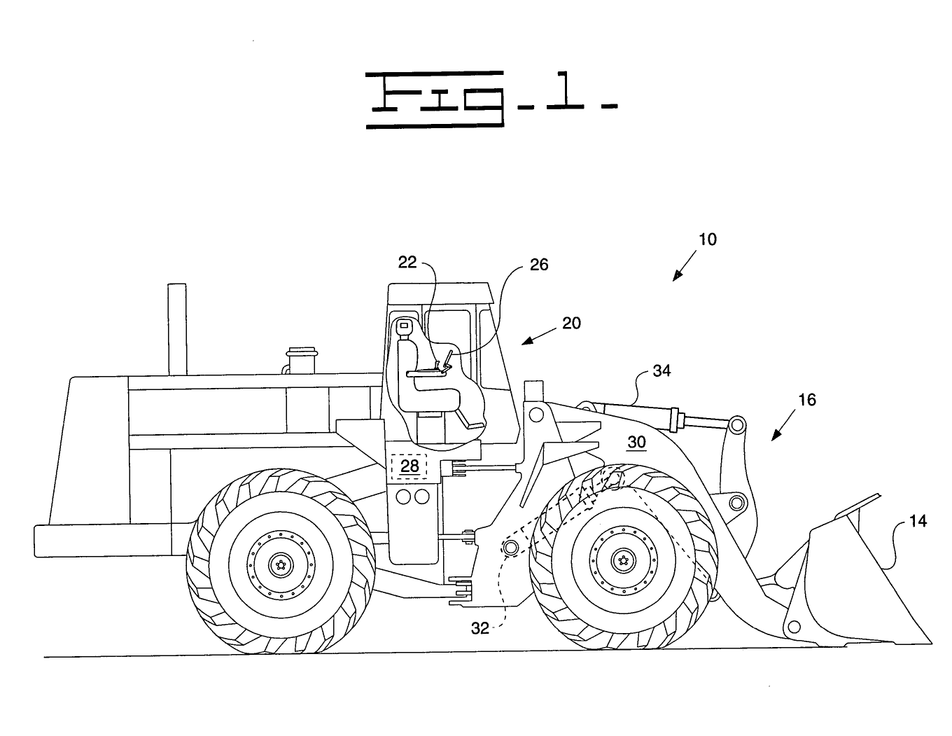

FIG. 1 shows a diagrammatic illustration of a machine 10 where one embodiment of the present disclosure may be employed. Although the machine 10 is shown as a wheel loader, the machine 10 may be any kind of mobile or stationary machine that generally has a need for data communications and power to be transmitted from one area on the machine 10 to another to enable the execution of an operation. For example, mobile machines may include wheel loaders, excavators, track type loaders, dump trucks, garbage trucks, marine propulsion systems, locomotives, etc. Stationary machines may include power generation systems, machining systems or other manufacturing tools and systems, etc.

The machine 10 displayed in FIG. 1 is shown having a variety of devices 60, including a power source (not shown), an implement 14, a lift mechanism 16, and an operator control station 20. The operator station 20 may include additional devices 60, such as a lift control device 22, a steering control device 24, and a display 26. The operator station 20, although shown here as being on the machine 10, may be on the machine itself or at a location remote from the machine 10. The machine 10 may also include at least one controller 28, the controller also being a type of device 60. The controller 28 preferably includes programming specific to the machine 10, but it should be appreciated that various aspects of the controller 28 may be common to all machines 10. The controller 28 may be microprocessor based, as is known in the art. In addition, the controller 28 may be one of a number of controllers for controlling different functions. The controller 28 may also control subservient controllers.

The machine 10 may have an implement 14 controllably attached to the machine 10 by the lift mechanism 16. The lift mechanism 16 may include a lift linkage 30 that may be hydraulically actuated by one or more hydraulic cylinders. In particular, lift linkage 30 and implement 14 may be controlled by lift cylinder 32 and tilt cylinder 34 to lift and tilt the implement 14.

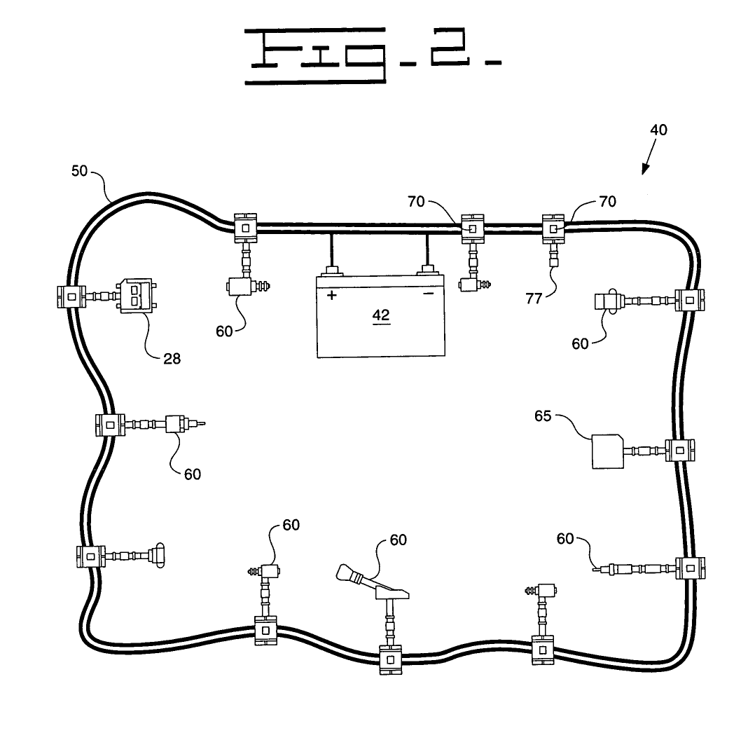

FIG. 2 shows diagrammatically a power and data delivery system 40 according to one embodiment of the present disclosure. The power and data delivery system 40 is arranged throughout the machine 10 and is connected to a power supply 42. The power and data delivery system 40 may include conductors such as a two-wire configuration, but may also include other configurations including, but not limited to, a one-wire configuration, for example with a common chassis ground. The power and data delivery system 40 may be arranged such that a conductor 50 is operably connected to all devices 60 requiring communication with the controller 28 or with other devices 60, and also requiring power from the power supply 42. The transfer of data and power preferably occurs over the same conductor 50. In addition to the devices 60 mentioned above, devices 60 may include, but are not limited to, solenoids, sensors, relays, throttle shifters, lights, alarms, and any other electrical device that may be present on the machine 10 or other machines. Devices 60 are operably connected to the conductor 50 via smart connectors 70. A smart connector 70 may also be characterized as a processing node. Each device 60 may have its own smart connector 70, as shown in FIG. 2.

Alternatively, the power and data delivery system 40 may be arranged and utilized on a portion of the machine 10. This may occur where new devices 60 are added to a machine 10 already having a wiring setup, such as a wiring harness. Furthermore, multiple systems 40 may be used on a machine 10. For example, a first system may be installed for the operator station of the machine 10 while a second system 40 may be installed for the rest of the machine 10. Similarly, separate systems 40 may also be used for cooling systems, implements, and the like. The systems 40 may then be connected to one another via smart connectors 70.

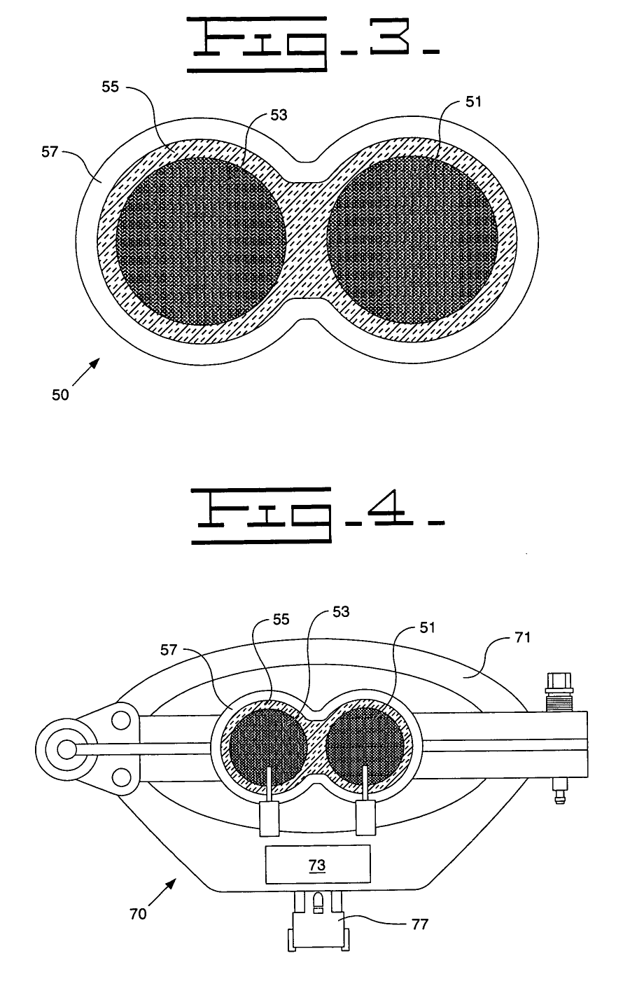

FIG. 3 is a cross section of the conductor 50 according to one embodiment of the present invention. The conductor 50 comprises a positive line 51 and a negative line 53. Each of the positive and negative lines 51, 53 may be made from a finely stranded material, such as copper, aluminum, or other material. The positive and negative lines 51, 53 may be disposed within an insulation 55 that electrically insulates and protectively surrounds the positive and negative lines 51, 53. Sheathing 57 may be arranged about the insulation 55 for an additional layer of protection from abrasion as well as to prevent electromagnetic interference (EMI) or emissions. Alternatively, the insulation 55 and sheathing 57 may be integrated as one component.

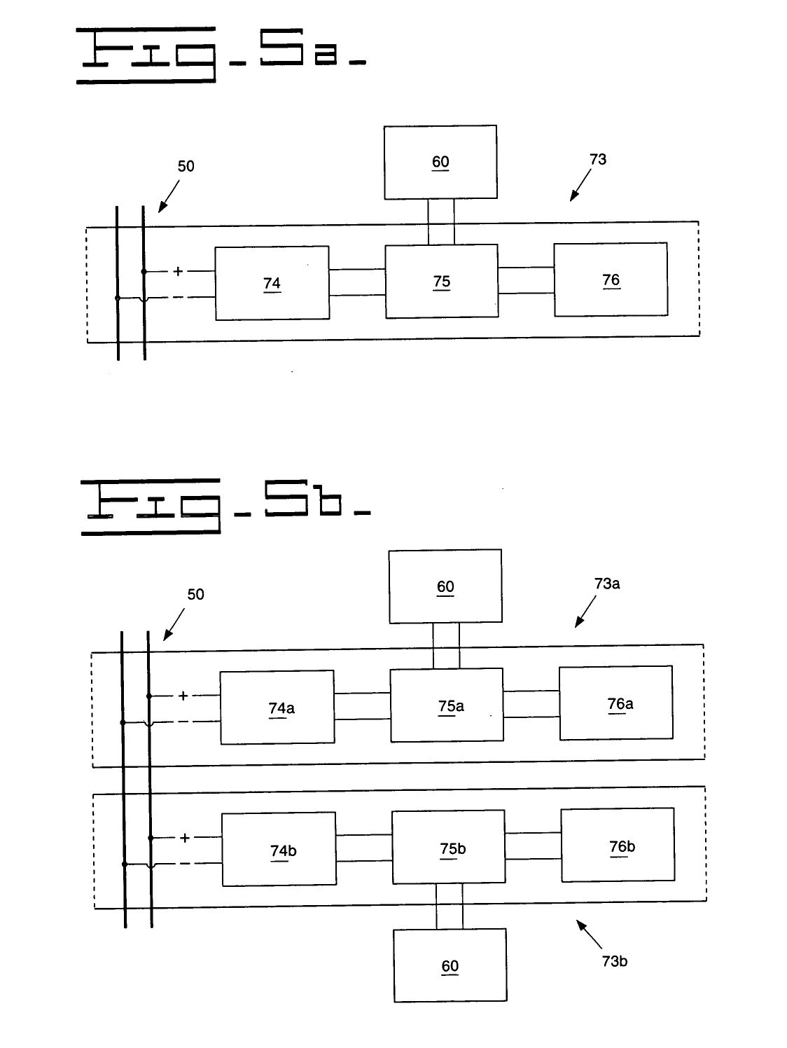

FIG. 4 is a cross section view of a smart connector 70 connected to the conductor 50 according to one embodiment of the present disclosure. The smart connector 70 may comprise a housing 71, prongs 72, a smart chip 73, and a device connector 77. The smart connector 70 may be connected to the conductor 50 at any location along the conductor 50 where it may be desired to connect a device 60. The connection of a smart connector 70 may occur during assembly of the machine 10 or at a later time, such as when a new device 60 may be added.

Connection of the smart connector 70 to the power and data conductor 50 may require that the smart connector 70 have at least one prong 72 that may penetrate the insulation 55 and sheathing 57 of the conductor 50 and independently contact a corresponding at least one of the positive and/or negative lines 51, 53. As shown in FIG. 4, there are 2 prongs 72, one prong 72 to contact the positive line 51 and one prong 72 to contact the negative line 52.

Ensuring a proper connection may include techniques such as clearly marking the conductor 50 and the prongs 72 with positive or negative markings, color codes or other types of markings so that the correct polarity between the contacts is made. In one embodiment of the disclosure, the prongs 72 may assume the shape of knife-like structures with a predetermined curvature for easier penetration into the conductor 50. The use of finely stranded lines in the conductor 50 allows the prongs 72 to readily penetrate into the positive and negative lines 51, 53 for enhanced electrical contact. The housing 71 may also allow for a predetermined offset of the prongs 72 from the conductor 50 such that assembly of the housing 71 about the conductor 50 will ensure a proper depth of penetration of the prongs 72 into the conductor 50.

Although the prongs 72 may be required to penetrate the sheathing 57 and insulation 55, various techniques may be used to establish a good connection. To prevent electrical continuity between prongs 72, it may be desired to coat the prongs 72 such that only the part of the prong 72 penetrating the conductor 50 into the stranded portion is conductive. This may be done using coatings and the like about the part of the prong 72 that may be in contact with the sheathing 57 or insulation 55. For example, a coating may be applied to portions of the prongs 72 that may be in contact with the sheathing 57 or insulation 55 or a coating may be applied to all but the end of the prongs 72. The coating should be a material that provides electrical insulation.

The smart connector 70 may be configured such that a sealant, e.g., a gel-like substance, may be located on the smart connector 70 and released during the connection process to completely seal the connection from the environment as the housing 71 closes about the conductor 50. The sealant may also be capable of coating portions of the prongs 72 as they penetrate into conductor 50 thereby providing insulation of a portion of each prong 72. Alternatively, the sealant may be located within the conductor 50, for example between the sheathing 57 and the insulation 55. If the sheathing 57 becomes exposed to the environment, the sealant at that location may harden and thus provide a barrier to maintain the integrity of the conductor 50. Using a sealant that may be of a material that hardens upon exposure to air may also prevent physical damage in case the sheathing 57 becomes frayed.

Design of the conductor 50 and the smart connector 70 may also allow for various configurations of the conductor 50 within the housing 71. The conductor 50 and the housing 71 may be configured such that the positive line 51 may only fit on one side of the housing 71 and the negative line 53 may only fit on the other side of the housing 71, thus allowing only for a proper polarity connection. Alternatively, the housing 71 may be configured such that connection to the conductor 50 may be made with the positive and negative lines 51, 53 contacting either prong 72. A contact device 74 may be located on the smart connector 70 to sense voltage polarity and may either provide an indication of a correctly polarized connection or reverse the polarity if not correct.

The smart connector 70 may be secured to the conductor 50 in one of a number of ways, including, but not limited to, adhesive, screws, bolts, clips, and the like. Securing the housing 71 to the conductor 50 by one of the above methods preferably maintains adequate connection in harsh environments.

Properly securing the housing 71 about the conductor 50 may equalize the compressive forces on the finely stranded wire bundle and may result in an overall stiffer region of the conductor 50. Having a stiffer region where the prongs 72 penetrate the conductor 50 may result in a reduction of fretting corrosion between the prongs and the finely stranded wire bundle of the conductor 50.

The smart connector 70 may connect to and make electrical contact with a device 60 by way of a device connector 77. The device connector 77 may be a pigtail connector or some other such connector suitable for the task. Alternatively, the device 60 may be connected to a smart chip 73a directly without any intermediate connector.

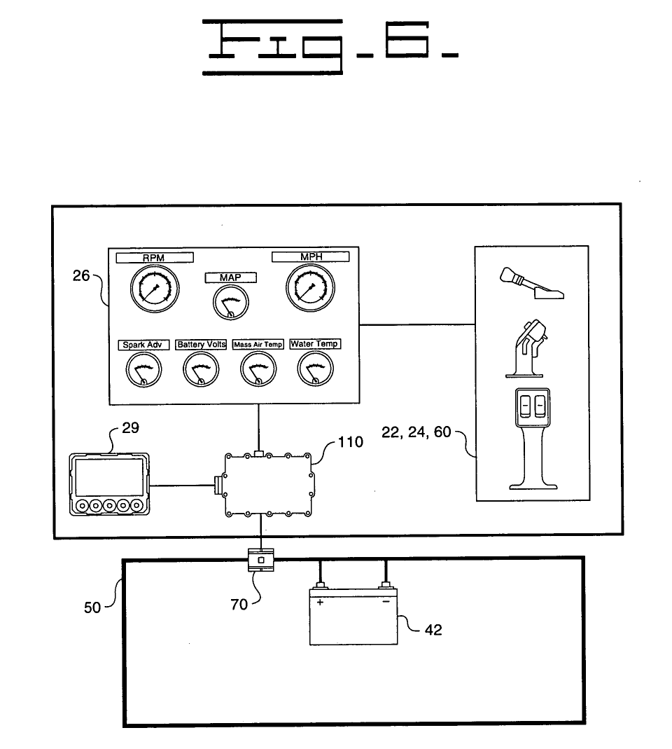

FIG. 5a is a block diagram of a smart chip 73 connected to the conductor according to one embodiment of the present disclosure. The prongs 72 may contact the conductor 50 as shown in FIG. 4. The smart chip 73 may comprise an optional contact device 74, a receiver/transmitter 75 and a processor 76.

The processor 76 may be programmed from a controller 28 through the receiver/transmitter 75, may be pre-programmed to recognize connection to a new device 60, may be programmed from the device 60 itself, or may be programmed utilizing any other device 60 having programming capability. A message may then be sent to a display 26 notifying the operator of a changed condition based on the programming. The changed condition may then be approved or denied based on an operator input or a predetermined system protocol. The smart connector 70 may then be enabled to communicate information through the conductor 50.

The smart connector 70 may transmit commands, inquiries, or other data to the device 60, and also receive data from the device 60. The smart connector 70 may then communicate by way of the conductor 50 to other smart connectors 70, devices 60, or the controller 28. When a communication is sent over the conductor 50, the communication may be available for all smart connectors 70 to review. However, only the smart connector 70 to which the communication is addressed will normally utilize the information. Although the signal may attenuate over time, the communication may remain on the conductor 50 indefinitely until filtered out by a signal attenuation device 65. The signal attenuation device 65 may filter or impede communications over a period of time such that the communication may be attenuated to an insignificant value, leaving the bandwidth of the conductor 50 available for new communications.

The smart connector 70 or the smart chip 73 may be available as off the shelf products. Thus, the smart connector 70, by use of standard components, may be a generic, interchangeable product.

The smart connector 70 may have built-in current limiting capabilities. The processor 76 may be programmed such that it may detect the current flowing to the device 60 and determine if the current is within tolerance. If the current is not within tolerance, the processor 76 may then stop or limit current flow to the device 60. The processor 76 may also send an out of tolerance message to an operator. Alternative means for limiting current flow may be used, such as resistors, capacitors, transistors, fuses, breakers, shunt devices, and the like.

The processor 76 may be programmed such that it may send communications over the conductor 50 on a predetermined frequency. This predetermined frequency may be operator selected based on a desired frequency, may be selected based on available bandwidth, or may be selected based on some other criteria, such as system condition, location, available communication means, regulated restrictions, and the like. Alternatively, the communication may be sent in multiple redundant packets using a plurality of frequencies or a plurality of communication protocols.

FIG. 5b is a block diagram of two smart chips 73a, 73b connected to the conductor 50 according to one embodiment of the present disclosure. A first processor 76a may send redundant packets to a second processor 76b. The second processor 76b receiving the redundant packets may compare the multiple communications for data integrity. The data may be considered completely and accurately delivered based on comparing the multiple communications with each other. For example, the communication may be sent redundantly over three separate frequencies, and a data match of at least two communications may indicate successful transmission. The number of required matches may depend on the type of data, the importance of the data, the speed required for data transfer, system conditions, external conditions, and the like. The second processor 76b, upon determining a successful transmission of data, may send a confirmation of data received. The confirmation may be sent to the first processor 76a or to a display 26 to provide notice to an operator. If the transmission of data is determined to be unsuccessful, i.e. the required number of matches is not received, the second processor 76b may notify either the first processor 76a, the operator, a designated source, or the like. In addition, the second processor 76b may ask for a re-transmission of the data. Because of either the lack of confirmation, a request for re-transmission, etc., the first processor 76a may recognize that the data is not being received by the second processor 76b and may then choose to send the data over different frequencies or in differing numbers of packets. This may continue until the data is received, the request is canceled, the operator is notified of the condition, and the like.

The display 26 may be configured to provide real-time, visual feedback on machine operating conditions. This may be used to ensure the best performance of the machine 10 and to assist in troubleshooting. The conductor 50 allows for multiple communication data links to be utilized in providing real-time performance and operating information while the machine 10 is in use. Alternatively, the information may be logged for future review. The display 26 may also be capable of showing one or more of the devices 60 that may be connected to the machine 10. This display 26 may also be configurable or re-configurable without changing out the hardware. Re-configuration may allow changes to the display 26 without utilizing additional current carrying devices.

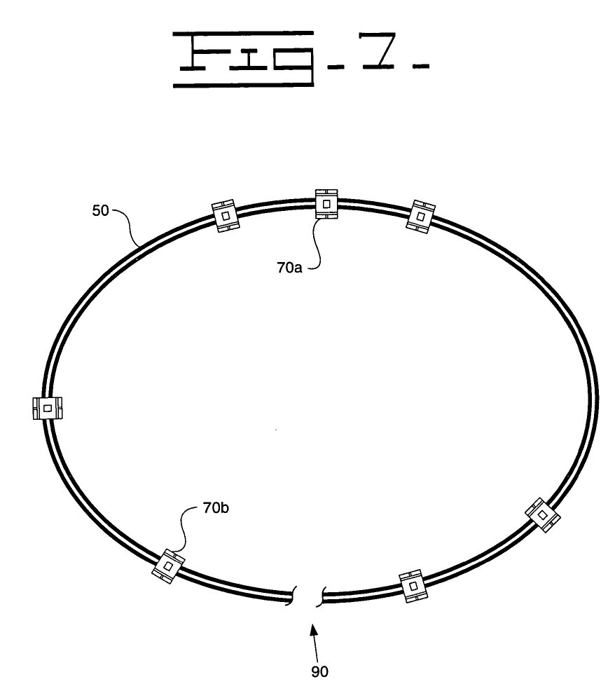

FIG. 6 shows diagrammatically a power and data delivery system 40 according to another embodiment of the present disclosure. In this embodiment, one smart connector 70 on the conductor 50 is connected to an operator interface station 100. The operator interface station 100 comprises an operator interface controller 110, a display 26, operator control devices 22, 24, 60, and software loading interface 29.

The software loading interface 29 may be available to allow an operator to load software and configure or reconfigure new and existing devices 60. The software loading interface 29 may also indicate the software programmed in each smart connector 70. Alternatively, this may be done automatically as mentioned above as devices 60 are connected to the conductor 50.

The display 26 in this embodiment may comprise a virtual dashboard display. The virtual display 26 may be configured to display various machine operator conditions, including RPM, speeds, temperatures, battery information, fuel indications, and the like. The display 26 may come pre-programmed from the manufacturer and have various configurable setups to select from or may be configurable to the owner's or operator's preferences. A virtual dashboard display 26 may eliminate the need for dedicated inputs. This may provide for reduced electrical power consumption, less wiring, and a greater overall system capacity. The display 26 may also be all or partly software based. This allows for the monitoring or control equipment to be consistent across product lines and machines.

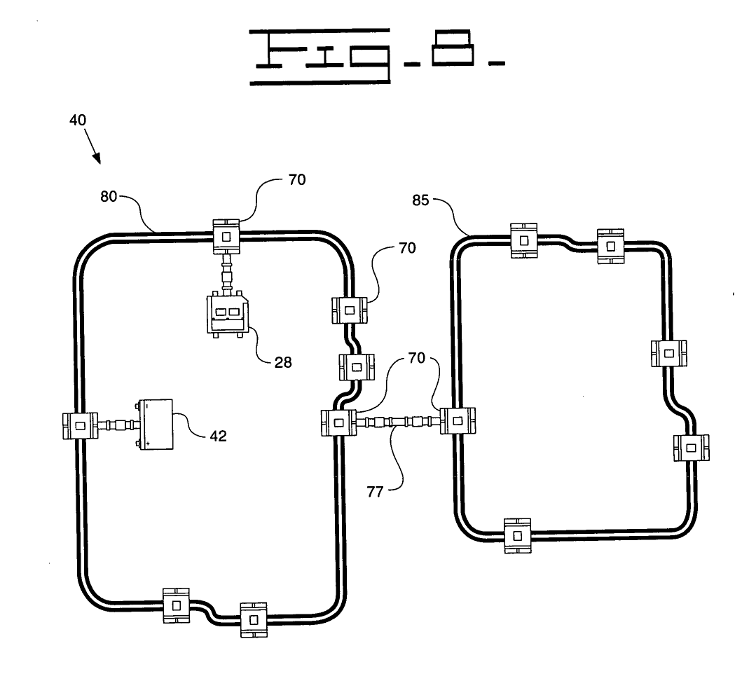

FIG. 7 shows diagrammatically a power and data delivery system 40 according to another embodiment of the present disclosure. Because the conductor 50 may be configured in a loop, a first smart connector 70a may transmit data on the conductor 50 to a second smart connector 70b that will travel in both directions from the first smart connector 70A. If a break 90 occurs in the conductor 50, the signal will only continue on the conductor until it reaches the break 90, at which time the signal will become fully attenuated. However, because of the loop configuration, the signal will still be capable of reaching the second smart connector 70b should a break 90 occur. Furthermore, a diagnostic mode may be built into the power and data delivery system 40 to assist in determining when and where a break 90 may have occurred in the conductor 50. For example, each smart connector 70 along the conductor 50 may be prompted to acknowledge receipt of a test signal. Failure to acknowledge by any smart connector 70 may indicate a smart connector malfunction or a break in the conductor 50. Further such diagnostic inquiries may yield more specific information.

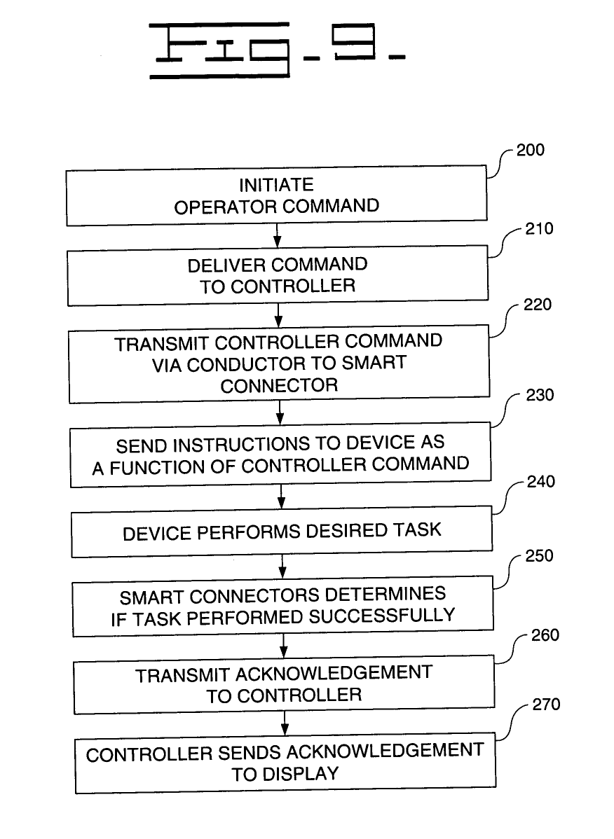

FIG. 8 shows diagrammatically a power and data delivery system 40 according to another embodiment of the present disclosure. Although the conductor 50 as discussed and as shown in FIG. 1 is shown in a loop configuration, it may be arranged in other acceptable configurations known in the art such as spider or straight-line configurations. Alternatively, the configuration may be similar to that shown in FIG. 8. FIG. 8 shows a two-loop configuration wherein a first conductor 80 and a second conductor 85 are in communication with one another via smart connectors 70 on each loop connected by a device connector 77. In this embodiment, power and data may be transferred from the first conductor 80 to the second conductor 85 and thereby to the devices 60 on the second conductor 85. Alternatively, the second conductor 85 may also have a second power supply (not shown) to provide power to devices 60 on the second conductor 85. In this embodiment, the connection between the first and second conductors 80, 85 may be wired as described above or may be wireless using technologies including, but not limited to, satellite or GPS, radio frequency (RF), cellular, and the like.

Industrial Applicability

The power and data delivery system 40 comprises a power supply 42, a conductor 50, smart connectors 70, and devices 60. After the system 40 is arranged on a machine 10, smart connectors 70, generally configured within housings 71, may be attached to the conductor 50 in locations near where devices 60 may desirably be located. The devices 60 may be attached to the smart connectors 70 through device connectors 77 that may allow for the transfer of power and data from the conductor 50 to the devices 60 through the smart connectors 70.

The present disclosure provides an improved system and method for power and data delivery on a machine 10. This system and method negate the need for today's cumbersome wiring harnesses, and enable greatly reduced costs due to reductions in the number of components and standardization of many key parts. Routing of the conductor 50 may be made substantially easier because of its reduced size and weight, thereby simplifying such tasks as making connections to devices, troubleshooting the system and devices, and adding devices as desired. This system and method makes upgrading older machines much easier and cost efficient. EMI may also be minimized due to the nature of the system configuration, i.e. the ability of having drivers close to driven devices, and the ability to send communications over multiple frequencies. The system 40 may also have the ability to perform additional functions. These functions may comprise power sharing, regeneration, high level diagnostics and prognostics, fuzzy logic based learning for performance optimization, site management, and other functions that, because of previous wiring configurations such as wiring harnesses, were too complex and burdensome to be commercially viable.

Embodiments of the present disclosure are applicable to a number of machines 10 where both power and data may be routed to devices 60 connected to those machines 10. FIG. 9 is a flow diagram depicting steps of operation of a power and data delivery system 40 according to one embodiment of the present disclosure. Once an operator initiates a command in a first control block 200, the command may be sent to a controller, as depicted in a second control block 210. According to the controller protocol, the controller command may be transmitted via the conductor 50 to a smart connector 70 for a device 60, as shown in a third control block 220. The smart connector 70 may then process the controller command and send instructions to the device 60 as a function of the controller command, as shown in a fourth control block 230. The device 60 may then perform the desired task according to its instructions, as shown in a fifth control block 240. The smart connector 70 may then determine if the task was performed successfully, as shown in a sixth control block 250 and transmit an acknowledgement through the conductor 50 to the controller 28, as shown in a seventh control block 260. Upon receipt of acknowledgement, the controller 28 may then send the acknowledgement to a display 26 for the operator to view, as shown in an eighth control block 270.

As an example of a particularly complex application of the present disclosure, a machine 10, such as a wheel loader, may be used to perform a lift function in which lift and tilt cylinders are controlled in coordination with one another for a process known as level lift. For example, as the machine 10 is used to pick up and drop off loads with the implement 14, various communications may occur within the system 40 to effectuate that movement. As the lift control device 22 is moved by the operator, the smart connector for the lift control device 22 may transmit a command through the conductor 50 for the lift cylinder 32. The smart connector for the lift cylinder 32 may then receive the command and cause the lift cylinder 32 to actuate. The smart connector for the lift cylinder 32 may then transmit data through the conductor 50 for the requesting smart connector confirming that the lift cylinder 32 is actuating.

The smart connector for the lift control device 22 may also transmit a request through the conductor 50 to query a position sensor (not shown) for the lift cylinder 32. Based on the query, the position sensor may make a reading and transmit that reading through the conductor 50 for the requesting smart connector. The smart connector for the lift control device 22 may then know the amount of extension of the lift cylinder 32 in relation to the tilt cylinder 34 and begin to transmit a command for the tilt cylinder 34 to actuate.

The smart connector for the tilt cylinder 34 may then receive the command and cause the tilt cylinder 34 to actuate. The smart connector connected to the tilt cylinder 34 may then transmit data through the conductor 50 for the smart connector for the lift control device 22 confirming that the tilt cylinder 34 is actuating.

The smart connector for the lift control device 22 may then transmit a request through the conductor 50 to query a position sensor (not shown) for the tilt cylinder 34. Based on the query, the position sensor may make a reading and transmit the reading through the conductor 50 for the requesting smart connector. The smart connector for the lift control device 22 may then know the amount of extension of the tilt cylinder 34 in relation to the lift cylinder 32.

The aforementioned communications may then continue to happen causing the implement 14 to maintain a level lift. All of the above communications may be made nearly simultaneously and the data for the movements may be traveling over the same conductor 50 at the same time. Furthermore, communications for other systems or subsystem of the machine 10, such as an engine control system, will also be passing data across the conductor 50 simultaneously to the data communications for a level lift.

A power and data delivery system 40 may also find application with a first conductor 80 found on a truck, i.e., a tractor of a tractor-trailer, and a second conductor 85 found on a trailer capable of operable connection to the truck. This application is similar to the embodiment of the present disclosure as shown in FIG. 8. The first conductor 80 may be capable of carrying power and data to a number of devices 60 on the truck including, but not limited to, lights, brakes, the engine, sensors, displays, etc. The second conductor 85 may be capable of carrying power and data to a number of devices 60 on the trailer including, but not limited to, controller 28, lights, brakes, GPS, climate control, etc.

Upon connection between the first and second conductors 80, 85, the controller 28 may be capable of recognizing that the smart connector 70 on the first conductor 80 is connected to another smart connector 70 on the second conductor 85. This connection may cause power and data to be carried to the second conductor 85 and allow for activation of the devices 60 on the second conductor 85. Alternatively, and as mentioned above, the connection between the first conductor 80 and the second conductor 85 may be done wirelessly. This may be done using GPS or RF electronics and may be based upon proximity of the trailer to the truck. Having GPS may also allow for additional functionality of the machines 10. GPS may assist in machine security as well as conformance with regulations based on machine location.

GPS and/or RF technology may allow for the presence of conductors 50 on separate mobile machines 10, such as two wheel loaders, wherein each wheel loader may have proximity alarms or warnings notifying the operators of another nearby machine 10. Having multiple conductors 50 may also simplify the arrangement of wiring on articulated machines where all wiring on a rear portion of the machine 10 must pass through the articulated joint. Separate conductors 50 may allow for a single device connector 77 between the conductor in the front portion and the rear portion of an articulated machine.

It will be apparent to those skilled in the art that various modifications and variations can be made in the system and method of the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

What is claimed is:

1. A power and data delivery system for a machine, comprising:
a conductor located throughout at least a portion of the machine;
a plurality of processing nodes, each connected to the conductor at a respective desired location; and
a plurality of devices, at least one being connected to a corresponding one of the plurality of processing nodes and controlled by the processing node;
wherein the desired location may be located at any point along the conductor.

2. The power and data delivery system of claim 1, wherein the conductor is operable to deliver at least one of power and data signals between power and data sources and the plurality of processing nodes.

3. The power and data delivery system of claim 2, wherein a selected at least one of the plurality of processing nodes is activated in response to receipt of the power and data signals.

4. The power and data delivery system of claim 3, wherein an activated processing node controls actuation of the connected device.

5. The power and data delivery system of claim 2, wherein each processing node is operable to transfer at least one of the power and data signals between the conductor and the connected device.

6. The power and data delivery system of claim 1, wherein the plurality of processing nodes are operable to transfer at least one of power and data signals over the conductor.

7. The power and data delivery system of claim 6, wherein the conductor is operable to deliver at least one of power and data signals between select processing nodes.

8. The power and data delivery system of claim 1, wherein the conductor is a two-wire conductor.

9. The power and data delivery system of claim 1, wherein the conductor is a one-wire conductor with a chassis ground.

10. A power and data delivery system for a machine, comprising:
a conductor located throughout at least a portion of the machine;
a plurality of smart connectors, each smart connector connected to the conductor at any desired location, the plurality of smart connectors operable to transfer at least one of a power and data signal through the conductor; and
at least one device being controllably connected to each of the plurality of smart connectors.

11. The power and data delivery system of claim 10, wherein each smart connector includes:
a processor for receiving the data signal and selectively delivering at least one of a control signal and a further data signal.

12. A machine having a power and data delivery system, comprising:
an electrical power source;
a data source;
a plurality of electrically driven devices;
a conductor for delivering power and data signals between the power and data sources and the plurality of devices; and
a plurality of processing nodes controllably connecting the signals from the conductor to the plurality of devices, each processing node being located at any desired location on the conductor.

13. The machine of claim 12, wherein the data source is provided by an electronic control module.

14. A method for connecting electrical devices to at least one of a power source and a data source on a machine, comprising:
installing a conductor throughout at least a portion of the machine;
connecting a processing node at any desired location along the conductor without interrupting an electrical path of the conductor; and
connecting at least one electrical device to the processing node.

15. The method as set forth in claim 14, further comprising:
configuring the connected electrical device for use with the machine.

16. The method as set forth in claim 14, further including:
notifying the operator of a changed condition on the machine.

17. The method as set forth in claim 14, wherein an electrical device is the power source.

18. The method as set forth in claim 14, wherein an electrical device is the data source.

19. A method for controlling an electrical device on a machine, comprising:
delivering electrical power and data signals on a conductor to a processing node directly connected to any location on the conductor; and
delivering actuation signals from the processing node to an electrical device as a function of the electrical power and data signals.

20. The method as set forth in claim 19, wherein an electrical device is controllably actuated by the processing node as a function of power and data source signals.
